(19) United States
(12) Patent Application Publication
(10) Pub. No.: US 2001/0033610 A1
(43) Pub. Date: Oct. 25, 2001

(54) Method for transmitting and receiving digital information over unused portions of licensed communication channels

(76) Inventor: William J. Chastain, Washington, DC (US)

Correspondence Address: SUGHRUE, MION, ZINN, MACPEAK & SEAS, PLLC, Suite 360, 1010 Camino Real, Menlo Park, CA, 94025, US

(21) Appl. No.: 09/780,877

(22) Filed: Feb. 9, 2001

Related U.S. Application Data
(60) Provisional application No. 60/195,860, filed on Apr. 7, 2000.

(51) Int. Cl. H04B 1/38; H04L 5/16

(52) U.S. Cl. 375/219; 375/295; 375/316

(57) ABSTRACT

A method for transmitting and receiving digital information utilizes unused parts of currently licensed communication channels for the purpose of connecting to a local loop network. Presently portions of communication channels licensed to UHF television broadcasters remain unused and the present invention uses these portions to establish a high-speed local loop connection to a network. This high-speed connection may support switched, digital wireline telephone services; telemetry and high-speed data services; television, video-on-demand and DTV services; and wireless base station integration into the switched telephone network. Resulting wireless broadband local loop connections will have a lower capital cost than with current conventional technologies.

### CROSS-REFERENCE TO RELATED APPLICATIONS

This application claims the benefit of Provisional Application No. 60/195,860, filed Apr. 7, 2000. The contents of that provisional application are incorporated by reference.

### BACKGROUND OF THE INVENTION

1. Field of the Invention

The apparatus and method of the present invention relate to broadband wireless communications specifically by transmitting and receiving digital data over unused portions of existing, licensed communication channels. For example, a television signal does not occupy the entire bandwidth of the channel to which it is assigned, and the unused portions of the channel can be applied to other uses. The present invention uses these portions to provide two-way high-speed access to a local loop network.

2. Description of the Related Art

The past decade saw the emergence and rapid growth of alternative communications networks, starting with alternative long distance carriers and extending through extensive bypass networks. With all the choices available in the communications market, the one segment that has seen little or no innovation has been the local loop network. A local loop is defined as the line from a subscriber's premises to the telephone company central office. A local loop network is a network of subscribers connected to a server by telephone lines, cable connections, or wireless means. Regulation has limited competition in the market for telephony, broadcast and cable television and cellular. Further, there is a perception that a second local loop network provider cannot effectively compete unless substantive cost savings are passed onto the subscriber. Deregulation and new technology are changing this situation.

It is impossible to identify all of the potential participants who will ultimately enter and shape the competitive market of the local loop through the 21^{st} century. However, three broad classes of network providers can be identified as either contemplating entering, protecting, or expanding their roles in the local loop market.

Local telephone companies have always stated that the local loop is the focal point of their business. With increasing deregulation, local telephone companies will begin to see more head-on competition and marketplace erosion of a segment that they have had almost exclusively to themselves. Market survival will require the local telephone companies to focus their efforts in four areas: first, reducing the capital in deploying distribution plant; second, increasing the capability of their local distribution system to support more than telephony services; third, reducing the cost to maintain and support their current distribution system infrastructure; and fourth, attempting to garner additional revenue by offering both long distance and non-telephony type service.

Broadcast and cable television operators have tended to focus on enhancing their video service. The greatest majority of these operators have been providing one-way services, and while there have been occasional threats to their franchises, no viable alternative to traditional television services emerged until local telephone companies began making entrees into the video distribution business. Many operators are beginning to realize that the underlying premise of their business is changing and that survival may require that they learn new marketing and operational skills. The key issues have been threefold for most operators: first, how do they finance the expansion of their current one-way video business; second, how do they leverage their current investment into two-way communications services; and third, how can operators market and support a business they know little or nothing about.

New entrants are probably the biggest unknown in the local loop market. These include new entrants from other industries such as the computer industry, long distance carriers who are beginning to move into the local market. In addition, utility companies, both private and municipal are providing their own communications networks as a means of staying connected with their customer base in this coming era of utility deregulation. To accomplish these goals, all of the new entrants are developing their own local communications networks that will directly connect to residential and commercial users. Depending upon each entrant's primary business focus, these networks may be designed as a telephone only, or as data only, or as a combined telephone and data network. For example, utility company applications are being developed on a network architecture that is primarily a data telemetry network that can also support switched voice and video applications. Furthermore, several private utilities have shown considerable interest in operating as an alternative telecommunications company, as they are ideally positioned to sell or lease excess bandwidth to either their customer base or to any number of competitive local loop network operators.

The network architecture of the future must be able to support today's network applications and be flexible enough to support additional applications as they emerge over the next twenty years. The four major service categories that the local loop must support are: switched, digital, wireline telephone service; telemetry and high-speed data services; television, video-on-demand and digital television (DTV) services such as high definition television (HDTV); and wireless base station integration into the switched telephone network.

In order to handle the above services, the ideal local loop distribution system will evolve to take on the following characteristics; high bandwidth, signal integrity, low cost, ease of handling, maintainability, a minimum of active components in the distribution and transport path, and allow for the sharing of the wireless bandwidth used or multiple cable drops off the main distribution system.

The existing telephone architecture of twisted pair wiring does not have these characteristics and, therefore, is physically incapable of providing the above mentioned services. While fiber optics has many of the necessary qualities, it is difficult to handle and the current state of fiber technology does not allow for multiple access points from main distribution system without a substantial number of active components. Additionally, a complete fiber optic network is not economically feasible to install to each home and business.

The emerging ideal distribution architecture is cellularized wireless system and or a system which is a hybrid of fiber optics and broadband coaxial cable. The advantage of such distribution networks is compelling; first, the distribution network is less expensive, considering first capital costs and operating costs, than conventional twisted pair, fiber-to-the home (FTTH), and fiber-to-the-curb (FTTC) distribution systems; second, the distribution network can accommodate multiple services.

Given the above benefits, it is somewhat surprising that the development of such systems has been slow. Several telecommunications vendors have announced services over the past two year period, but few have been able to commercially deliver such services to the field, and those that have been introduced, provide a single function, i.e., high-speed internet access that precludes use of the same system bandwidth for other applications. This lack of choice in services from multiple vendors has slowed the development of the market, both domestically and internationally. Further, current “wireless” services offer only a wireless downstream connection but require a wired upstream connection to communicate with the service. Such a requirement slows the speed of the connection and renders some of the proposed uses infeasible.

There is a need for a low cost local loop network that can offer a combination of any or all of the services relating to telephony, high-speed data, video including DTV, and wireless base station. Additionally, such a low cost local network could use such resources as are presently available. A service which employs the unused portions of television signals in the ultra-high frequency spectrum (UHF), having frequency ranges from 300 MHz to 3,000 MHz, currently licensed to full power television stations, low power television stations (LPTV), or institutional television fixed service (ITFS), microwave multipoint distribution systems (MMDS) can be developed at low cost and can provide all networking services. Such a service would obtain spectrum from current license holders and employ devices that would enable a subscriber to the service to communicate data to the service and receive data from the service by wireless transmissions over the designated radio frequencies. However, such a service need not be limited to the UHF band but could use other frequency bands such as very high frequency (VHF) which is from 30 MHz to 300 MHz or such frequency bands available above UHF, including ultra wide band (UWB) technologies.

### SUMMARY OF THE INVENTION

In a preferred embodiment, the present invention provides an apparatus and method to enable a subscriber to connect with a local loop network using wireless communications operating in unused portions of the UHF spectrum currently operated by others. The system operator would be able to both transmit and receive digital information for the purposes of telephony, high-speed data, video distribution, video conferencing, wireless base operations and other similar purposes. The apparatus will consist of equipment and devices at the system operator's location and equipment and devices at the service subscriber's location.

At the service operator's location, the equipment and devices will comprise a wireless modem hub which contains upstream demodulators and downstream modulators, a data switch/router, a network manager, a transmitting antenna, a receiving antenna and associated cabling and electronics.

The equipment and devices at the subscriber's location will comprise an antenna and associated electronics for transmitting and receiving a signal to and from the system's antennas, a wireless modem transceiver for converting the information and devices for using the information such as computers, network servers, digital or subscription televisions, interactive media devices such as set-top boxes and telephone switching equipment.

In another embodiment, the system provider's transmitting and receiving antennas would be cellularized, and the remote hubs would relay traffic back to the primary access point through the use of point-to-point links such as analog optical fiber or out of band microwave links.

In a still further embodiment, digital television signals can be multiplexed with the digital data to provide digital services to the system subscribers. Such digital television signals could be an MPEG video stream or other data compression scheme.

In yet another embodiment, the local loop network would be connected to existing cable networks and to data networks including the internet through existing wire, optic fiber connections, or microwave links.

### BRIEF DESCRIPTION OF THE DRAWINGS

These and other features and benefits of the invention will be readily appreciated in light of the following detailed description of the preferred embodiments thereof, given by way of example only with reference to the accompanying drawings wherein:

FIG. 1 shows a preferred embodiment of the inventive method for transmitting and receiving digital information,

FIG. 2 shows equipment at a subscriber's location,

FIG. 3 shows another arrangement of the transmitting and receiving antennae,

FIG. 4 shows another embodiment of the inventive method for transmitting and receiving digital information,

FIG. 5 shows yet another embodiment of the inventive method for transmitting and receiving digital information,

FIGS. 6a and 6b show a method for using the disclosed invention.

### DETAILED DESCRIPTION OF THE PREFERRED EMBODIMENTS

Preferred embodiments of the present invention will now be described with reference to the attached drawings, wherein identical elements are designated with like numerals.

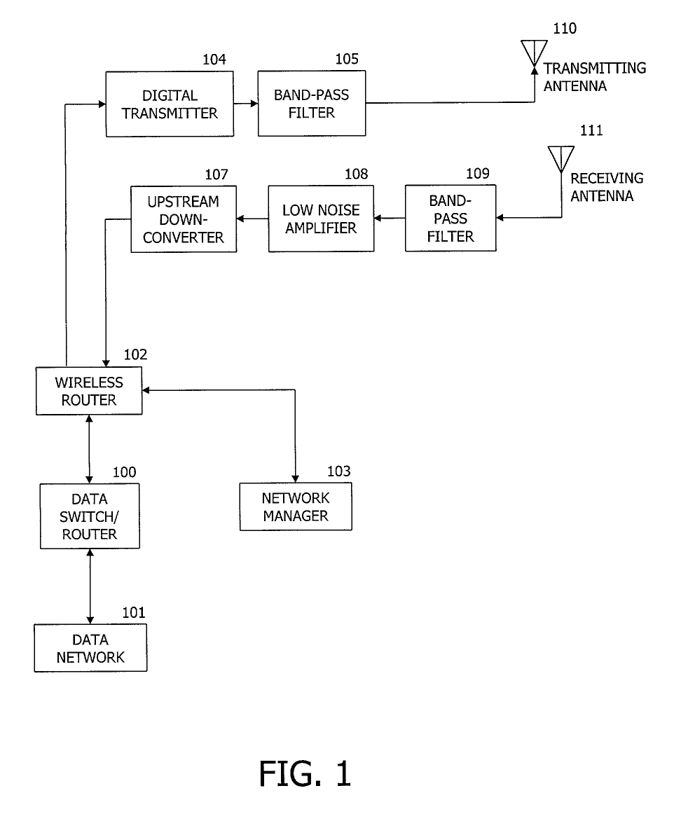

Referring now to FIG. 1, downstream digital data from a source such as the internet 101 is passed to a data switch/router 100. The downstream digital data is then passed to the radio frequency (RF) wireless router 102 which is controlled by a network management system where the data is modulated and passed to the transmitter 104. The transmitter 104 is tuned to a first unused portion of a licensed communication channel and in turn passes the downstream digital data through a band pass filter 105 to remove spectral regrowth of the signal and then to a transmitting antenna 110.

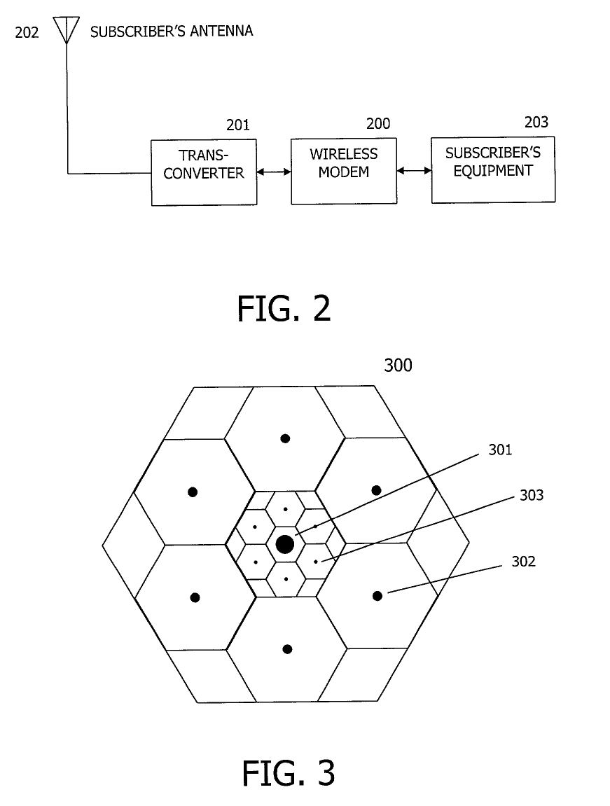

Referring now to FIG. 2, the downstream digital data is received by a subscriber's antenna 202 and passed through a transconverter 201 to the wireless modem 200. The downstream digital data then is demodulated by the wireless modem 200 and passed to the subscriber's equipment 203 for use which may be telephony, high-speed data or video signals. When it is necessary for the subscriber's equipment 203 to send instructions or data back to the network, the upstream digital data is modulated by the wireless modem 200 and passed to the transconverter 201 for transmission by the subscriber's antenna 202. The transconverter 201 will operate on a second unused portion of a licensed communication channel using variable power depending on the distance from the subscriber to any receiving antennae.

It is within the scope and contemplation of this invention to configure the transconverter 201 to operate on any frequency including ultra wide band (UWB) frequencies whether licensed or not.

Returning again to FIG. 1, the upstream digital data is received by a receiving antenna 111 and passed through a band pass filter 109 to remove undesired neighboring signals. After filtering, the upstream digital data is amplified by a low noise amplifier 108 and passed to an upstream downconverter 107 for conversion to an intermediate frequency that can be received by the wireless router 102. The wireless router 102 then demodulates the upstream digital data and the data passes through the data switch/router 100 to a data network such as the internet 101.

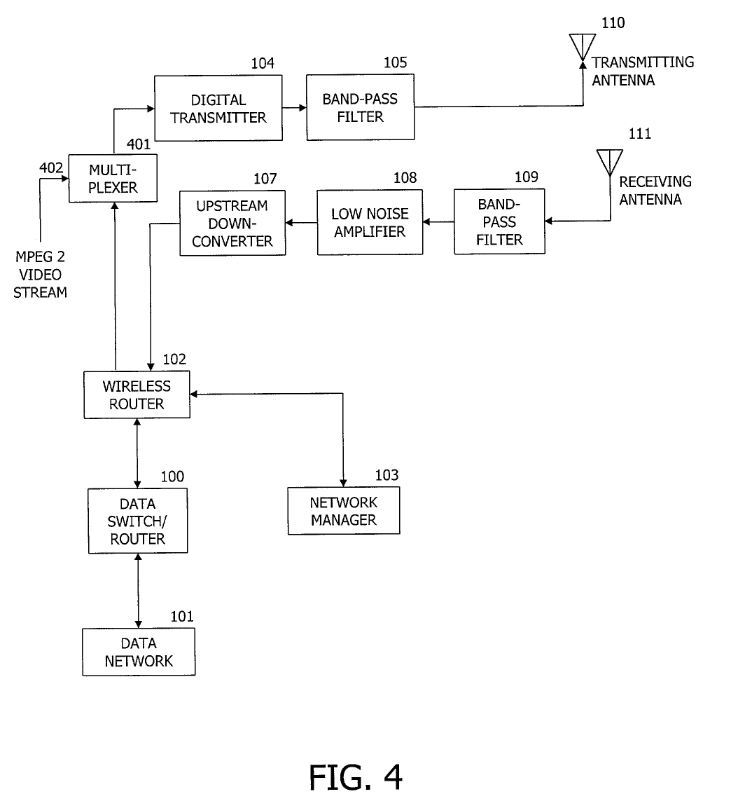

In another preferred embodiment, FIG. 3, the transmitting antenna 110 and receiving antenna 111 of FIG. 1 are replaced by an array of transmitting and receiving antennae 300. In order to reuse frequencies and to tailor the reception area, the broadcast and reception area of the primary hub antenna 301 is further subdivided to provide for remote hubs 302 and secondary hubs 303. The configuration for a geographical region is dependent on many variables such as locations of mountains and lakes or the number of subscribers in a particular area. Each of the remote hubs 302 and secondary hubs 303 would be connected to the primary hub 301 by point-to-point links such as fiber optic cable, microwave links, or infrared lasers or other point-to-point technologies. Another consideration is the transmitting power of the wireless modem 200 located at the subscriber's location. It is anticipated that the reception area of a secondary hub 302 will be about 4 miles, that of a remote hub will be about 12 miles and that of the primary hub would be about 36 miles. A skilled practitioner in wireless and cellular communications will recognize the advantages of this embodiment.

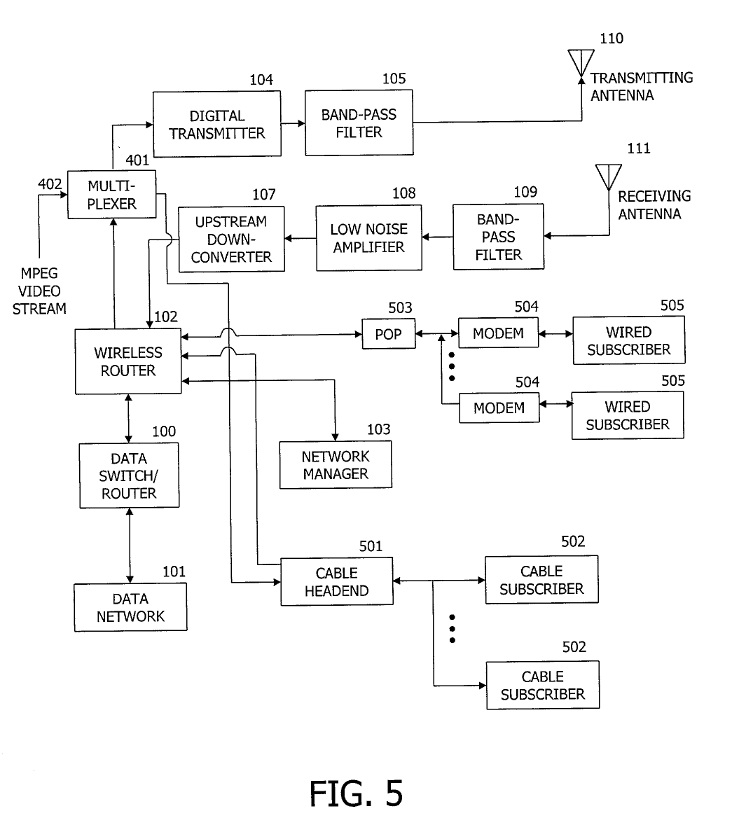

In still a further preferred embodiment, now referring to FIG. 4, it is advantageous to transmit digital data which comprise a digital television signal. This digital data is in the form of an MPEG video stream 402. MPEG is an acronym for Motion Picture Experts Group which has developed standard data protocols for the compression and transmission of, among other things, digital television signals. MPEG is one of the standards developed and this standard supports CD audio quality full screen, full motion and full color television picture as well as the new DTV format. The MPEG video stream 402 is combined with the downstream digital data in a multiplexer 401 and the combined signal is then passed to the digital transmitter 104 for transmission in the same manner described above.

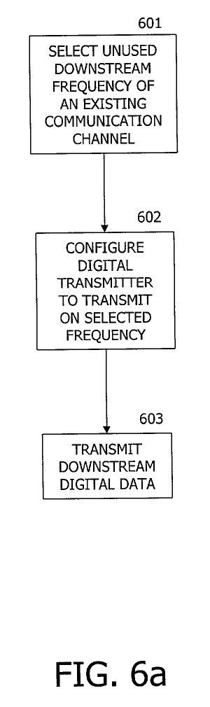

In yet a still further preferred embodiment, referring now to FIG. 5, it is advantageous to transmit digital data to subscribers who are already connected by an existing cable or by existing telephone lines through a point of presence (POP) 503. A POP is one of several modems connected to the wireless router 102 which allow a dial-in connection from a subscriber modem 504. Two-way network connections using cable or telephone lines are well known by skilled practitioners in the art and will not be described herein. An existing cable network may be connected to the wireless network by connecting the cable headend 501 to the wireless router 102 and the multiplexer 401. This allows all cable subscribers 502 or wired subscribers 505 to be interconnected with all wireless subscribers. A wired subscriber 505 may receive downstream digital data by a subscriber's antenna 202 and send data or instructions back to the network using a modem 504 and POP 503. The wireless router 102 may be configured to send to and receive digital data from subscribers using any of licensed or unlicensed communication channels, cable connections, or wired connections. It is advantageous to transmit and receive digital data from subscribers independent of the means of transmission thereby connecting subscribers using differing means of communication.

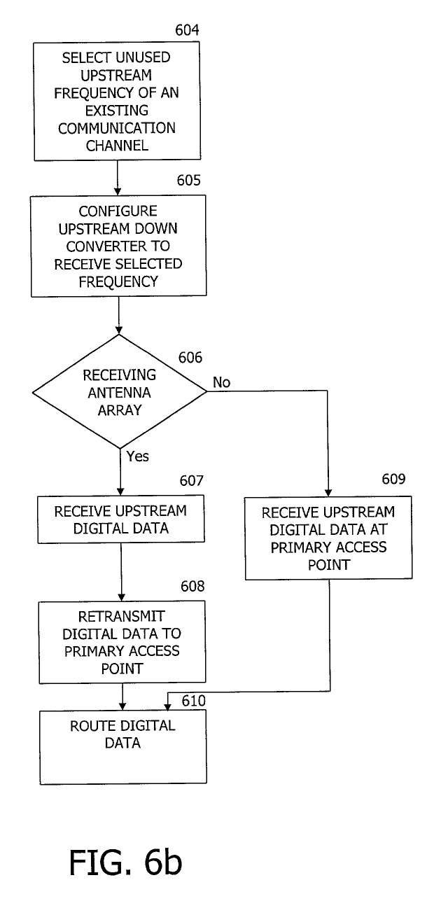

Turning now to a description of how to use the disclosed invention, referring now to FIGS. 6a and 6b, the first step (block 601) is to identify and select a first unused portion of a currently operating licensed communication channel preferably in the UHF spectrum. Once the frequency is selected, then the transmitter needs to be configured (block 602) to operate on that frequency. Because the frequency is within an existing operating licensed channel, all other transmission equipment has already been determined. Once configured, digital data may be transmitted (block 603) on the selected frequency which is a first unused portion of a currently licensed communications channel.

Downstream digital data is transmitted responsive to requests for data and commands sent by subscribers. In order to receive such commands and requests, an upstream frequency is selected (block 604) in a second unused portion of a communications channel. The upstream channel may be a different channel from that used in downstream data communications. The upstream downconverter is then configured (block 605) to receive the selected frequency. If there is an array of receiving antennae (as determined in block 606), then upstream digital data is received (block 607) at its associated hub. If there is no array of receiving antennae, the primary hub receives (block 609) the upstream digital data and in either case, the digital data is routed (block 610) by the data switch/router for further processing.

With respect to the above description, then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Having thus described our invention, what we claim as new, and desire to secure by Letters Patent is:

1. A method for transmitting data in unused portions of licensed communication channels comprising:
selecting an unused first portion of a first licensed communication channel,
configuring a transmitter to operate in said unused first portion, and
transmitting downstream digital data using a transmitting antenna operating on said first portion.

2. The method of transmitting data of claim 1 further comprising:
selecting an unused second portion of a second licensed communication channel,
configuring an upstream downconverter to operate in said unused second portion, and
receiving upstream digital data using a receiving antenna operating on said unused second portion.

3. The method of transmitting data of claim 2 wherein said first communications channel and said second communications channel are different.

4. The method of transmitting data of claim 1 wherein said downstream digital data is selected from a group consisting of telephony signals, high-speed data, digital video signals and DTV signals.

5. The method of transmitting data of claim 1 further comprising enabling a subscriber to select a method of transmitting upstream data from using the unused second portion, using a cable connection, and using a wired connection.

6. The method of transmitting data of claim 1 wherein said transmitting antenna comprises an array of transmitting antennae.

7. A method for receiving data in unused portions of licensed communication channels comprising:
selecting an unused first portion of a first licensed communication channel,
configuring an upstream downconverter to operate in said unused first portion, and
receiving upstream digital data using a receiving antenna operating on said first portion.

8. The method for receiving data of claim 7 further comprising the steps of:
selecting an unused second portion of a second licensed communication channel,
configuring a transmitter to operate in said unused second portion, and
transmitting downstream digital data using a transmitting antenna operating on said unused second portion.

9. The method for receiving data of claim 8 wherein said first communications channel and said second communications channel are different.

10. The method for receiving data of claim 7 further comprising enabling a subscriber to select a method of transmitting upstream data from using the unused first portion, using a cable connection, and using a wired connection.

11. The method for receiving data of claim 7 wherein said upstream digital data is selected from a group consisting of telephony signals, high-speed data, digital video signals and DTV signals.

12. The method for receiving data of claim 7 wherein said receiving antenna comprises an array of receiving antennae.

13. The method for receiving data of claim 7 wherein said transmitting antenna comprises an array of transmitting antennae.

14. A method for transmitting and receiving data in unused portions of licensed communication channels comprising:
selecting an unused first portion of a first licensed communication channel,
configuring a transmitter to operate in the said unused first portion,
transmitting downstream digital data using a transmitting antenna operating on said first portion,
selecting an unused second portion of a second licensed communication channel,
configuring an upstream downconverter to operate in the said unused second portion, and
receiving upstream digital data using a receiving antenna operating on said unused second portion.

15. The method for transmitting and receiving data of claim 14 wherein said first communications channel and said second communications channel are different.

16. The method for receiving and receiving data of claim 14 further comprising enabling a subscriber to select a method of transmitting upstream data from using the unused second portion, using a cable connection, and using a wired connection.

17. The method for transmitting and receiving data of claim 14 wherein said downstream digital data and said up stream digital data is selected from a group consisting of telephony signals, high-speed data, digital video signals and DTV signals.

18. The method for transmitting and receiving data of claim 14 wherein said receiving antenna comprises an array of receiving antennae.

19. The method for transmitting and receiving data of claim 14 wherein said transmitting antenna comprises an array of transmitting antennae.
